(19) United States
(12) Patent Application Publication
(10) Pub. No.: US 2024/0270642 A1
(43) Pub. Date: Aug. 15, 2024

(54) Method of preparing a cement plastic mixture

(71) Applicant: Terratico, j.s.a., Zilina (SK)

(72) Inventors: Otto Nagy, Horny Bar (SK); Otto Nagy, Horny Bar (SK)

(21) Appl. No.: 18/567,445

(22) PCT Filed: Jun. 7, 2022
(86) PCT No.: PCT/SK2022/000006

§ 371 Date: Dec. 6, 2023

(30) Foreign Application Priority Data
Jun. 7, 2021 (SK) PP 41-2021
Jun. 7, 2021 (SK) PU V 85-2021

(51) Int. Cl. C04B 18/20; C04B 14/06; C04B 14/44; C04B 18/14; C04B 28/04; C04B 103/12; C04B 103/32

(52) U.S. Cl. CPC C04B 18/20; C04B 14/06; C04B 14/44; C04B 18/146; C04B 28/04; C04B 2103/12; C04B 2103/32

(57) ABSTRACT

A method of preparing a cement plastic mixture is based on the fact that in the first step plastic crumb, cement water and optionally silica sand are mixed in a mixing device at a temperature 8° C. to 25° C. for 3 minutes. In the second step, at least one of the following components is added: superplasticizer, solidification accelerator, synthetic fiber, paint and optionally silica fume (microsilica) Si0₂ for 9 minutes.

### RELATED APPLICATIONS

This application is a national stage application of international patent application PCT/SK2022/000006, filed Jun. 7, 2022, which claims priority to Slovakia Patent Application No. PP 41-2021, filed Jun. 7, 2021, and to Slovakia Patent Application No. PUV 85-2021, filed Jun. 7, 2021, all of which are hereby incorporated by reference in their entirety.

### FIELD OF TECHNOLOGY

The invention relates to a method of preparing a cement plastic mixture usable for the production of construction and stone products. The invention falls into the field of construction and stonework.

### BACKGROUND

At present, products based on cement, silica sand and stone, granite or marble crumb such as e.g. terrazzo are commonly known in the field of construction and stonework. Terrazzo is a composite material, poured in place or precast, which is used for floor and wall treatments. It comprises chips of marble, quartz, granite, glass, or other suitable material, poured with a cementitious binder (for chemical binding), polymeric (for physical binding), or a combination of both.

The document RU 2739910 C1 is known in the prior art, which describes a polymer-cement dry construction mixture which contains Portland cement, a polymeric binder, sand, glass fiber and a modifier. The polymeric binder is redispersible polyvinyl acetate polymer powder or polyvinyl acetate copolymers.

Two-component fast-setting plastic cement is also known from the document CN 112063160 A, where the first component is a polyether polyol, a curing agent, a surface hydroxylated modified paraffin, a thickener and a solid filler. The second component is a polyether polyol, a catalyst, a crosslinking agent, paraffin modified by a surface hydroxyl group, a thickener and a solid. Paraffin with certain hydroxyl content is introduced into these two components.

There were also tendencies to mix acrylate rubber asphalt into the cement, as is the case with the utility model SK 1692 U, in order to reduce the bulk density, increase the thermal insulation properties and ensure water impermeability.

A building mix comprising cement and paper pulp is also known, as described in utility model SK 4239 U, which saves on production costs and reduces the weight of the product.

All of the above-described building mixtures, also based on cement, have their own specific preparation methods.

The problem of cement mixtures, which has not yet been fully explored, has at present evoked to design such a composition of the cement mixture and the method of its preparation that would also allow the ecological use and consumption of plastic waste. The result of this effort is the method of preparing a cement plastic mixture described in the present invention.

### DETAILED DESCRIPTION

The above-mentioned problem of cement mixtures is solved by the proposed cement plastic mixture which may be prepared in a specific way according to the invention. For the purposes of the present invention, the term “cement plastic mixture” may be understood as meaning a composition of the following composition. It may be a mixture that contains crushed plastics preferably which cannot be further recycled. It is possible to use plastics of all kinds preferably with a fraction of 1 mm to 20 mm, or even a higher fraction, or chopped plastic strips, except for plastic pellets. It is also cement, e.g. Portland gray or white with a strength of 32.5 MPa to 52.5 MPa.

Portland grey and Portland white represent historical names for a cement which may be used as a synonym for hydraulic binder.

Finally, a superplasticizer may be used, e.g. Melment, a superplasticizer based on melamine formaldehyde resin with a density of 20/40, and water. According to the present invention the superplasticizer may be based on or may comprise or may be made from melamine formaldehyde and/or may fulfill the EN 934-2 2019+A1:2012 standard. The mixture may further contain silica sand with a fraction 0.3 mm to 2.0 mm and/or solidification accelerator, e.g. Betodur A5, thus a chloride free concrete and/or synthetic fibers, e.g. ARC 42/30 mm, namely alkali resistant (AR) Glass Fibers, which may be designed specifically for use in concrete and/or powdery paint and/or silica fume (microsilica) SiO₂. These components of the mixture may be present in the following percentage of the individual components:
29% of weight to 43% of weight of plastic crumb;
56% of weight to 69% of weight of cement;
1.0% of weight to 2.0% of weight of superplasticizer adding up to 100% and representing a basic mixture.

At least one additional additive component is added to the basic mixture, comprising or consisting of:
6.0% of weight to 12% of weight of silica sand; and/or
0.4% of weight to 0.9% of weight of solidification accelerator; and/or
0.04% of weight to 0.07% of weight of ARC synthetic fibers; and/or
0.02% of weight to 0.08% of weight of paint; and/or
4.0% of weight to 14.0% of weight of water; and/or 4.0% of weight to 15.0% of weight of silica fume (microsilica) SiO₂.

The percent of weight of additional ingredients according to the present invention is meant as a percentage that is additional to the weight of the basic mixture such that the final product has Y weight units (e.g, kilogram(s)) of basic mixture+e.g. 6% additional weight of additional ingredients adding up to a total mass Y*1.06 of the mass of the basic mixture according to this example.

Thus, the weight percentage of additional ingredients comes on top of the mass of the basic mixture and is calculated as if the basic mixture without the additional ingredients was 100% leading in the above example to a total final product (cement plastic mixture) mass of 106% with respect to the mass of the basic mixture.

The essence of the method of preparation of the cement plastic mixture according to the invention lies in the fact that:
In the first step, plastic crumb, cement, water and optionally silica sand at a temperature of preferably 8° C. to 25° C. preferably for 3 minutes to 4 minutes are mixed in a mixing device; and

In the second step, at least one of the components is added: superplasticizer and/or solidification accelerator and/or synthetic fibers and/or paint and/or optionally microsilicate SiO₂ preferably mixed for 6 minutes to 10 minutes.

The result of mixing is high-strength cement plastic mixture with a self-leveling density.

The advantages of the method of preparing a cement plastic mixture according to the invention are evident from its external effects. The effects and originality lie in that the unique composition of the mixture is mixed in a specific way at a precisely defined order of addition of the components of the mixture and/or time intervals of mixing.

From this cement plastic mixture according to the invention, it is possible to produce garden furniture, e.g. benches, flower pots, rubbish baskets, tables, large-format paving, facade elements and cast prefabricated parts, that can be cut, sanded, sandblasted, impregnated, and similarly machined with chip or non-chip technologies.

### Example of an Embodiment of the Invention

It is understood that the individual embodiments of the method of preparing a cement plastic mixture according to the invention are presented for illustration and not as limitations of solutions. Those skilled in the art will find, or be able to ascertain using no more than routine experimentation, many equivalents to specific embodiments of the method of preparing a cement plastic mixture according to the invention. Such equivalents will also fall within the scope of the claims.

It is not a problem for those skilled in the art to optimally mix the individual components of the cement plastic mixture with the respective mixing times, so these features have not been addressed in detail.

### Example

In this example of a specific embodiment of the invention, the method of preparing a cement plastic mixture according to the present invention is described.

Cement plastic mixture of the following composition is prepared:
29% of weight to 43% of weight of plastic crumb;
56% of weight to 69% of weight of cement; and
1.0% of weight to 2.0% of weight of superplasticizer.

Further, to the weight of the basic mixture, at least one additional ingredient may be added comprising or consisting of:
4.0% of weight to 14.0% of weight of water; and/or
6.0% of weight to 12% of weight of silica sand; and/or
0.4% of weight to 0.9% of weight of solidification accelerator; and/or
0.04% of weight to 0.07% of weight of ARC synthetic fibers; and/or
0.02% of weight to 0.08% of weight of paint; and/or
4.0% of weight to 15% of weight of silica fume (microsilica) SiO₂.

A cement plastic mixture of this composition is prepared by:
In the first step, plastic crumb, cement, water and optionally silica sand are mixed in a mixing device preferably at a temperature 8° C. to 25° C. for preferably 3 minutes; and
In the second step, at least one of the components is added: superplasticizer and/or solidification accelerator and/or synthetic fibers and/or paint and/or silica fume (microsilica) SiO₂ mixing for preferably 9 minutes.

The result of mixing is high-strength cement plastic mixture with a self-leveling density.

### INDUSTRIAL APPLICABILITY

The method of preparing a cement plastic mixture according to the present invention is intended for the field of construction and stonework.

1. A method of preparing a cement plastic mixture, comprising:
mixing, in a mixing device and at a temperature of 8° C. to 25° C. for 3 minutes to 4 minutes, a basic mixture of:
29% of weight to 43%, of weight of plastic crumb;
56%, of weight to 69% of cement; and
4.0% of weight to 14.0%, of weight of water; and
mixing, in the mixing device for 6 minutes to 10 minutes:
1.0% of weight to 2.0% of weight of superplasticizer; and
at least one of:
0.4% of weight to 0.9% of weight of solidification accelerator;
0.04% of weight to 0.07% of weight of ARC synthetic fibers; and
0.02% of weight to 0.08% of weight of paint.

2. The method of preparing the cement plastic mixture of claim 1, wherein the basic mixture further includes 6.0% of weight to 12% of weight of silica sand with a fraction 0.3 to 2.0 mm.

3. The method of preparing the cement plastic mixture of claim 1, further comprising mixing 4.0% of weight to 15% of weight of silica fume (microsilica) SiO₂.
